(19) United States
(12) Patent Application Publication
(10) Pub. No.: US 2024/0021212 A1
(43) Pub. Date: Jan. 18, 2024

(54) Accelerometer-Based Voice Activity Detection

(71) Applicant: InvenSense, Inc., San jose, CA (US)

(72) Inventor: Remi Louis Clement Poncot, Grenoble (FR)

(21) Appl. No.: 18/218,953

(22) Filed: Jul. 6, 2023

Related U.S. Application Data
(60) Provisional application No. 63/388,356, filed on Jul. 12, 2022.

(51) Int. Cl. G10L 25/78; H04R 1/10; G10L 15/08

(52) U.S. Cl. CPC G10L 25/78; H04R 1/1041; H04R 1/1016; G10L 15/083; G10L 2015/088

(57) ABSTRACT

An example embodiment includes a head worn electronic device comprising a transceiver for communicating with a host device, an accelerometer having a plurality of axes for detecting three-dimensional forces applied to the head worn electronic device, and a processor. The processor is configured to receive a three-dimensional vibration vector from the accelerometer caused by a voice of a user while the head worn electronic device is positioned in a user's ear, process the three-dimensional vibration vector to determine a voice activity detection axis that correlates with vibrations caused by the voice of the user, perform processing of data from the voice activity detection axis to detect voice activity of the user, and send an instruction to the host device via the transceiver to control the host device based on the voice activity detection.

### CROSS REFERENCE TO RELATED APPLICATIONS

This application claims priority to U.S. Provisional Application No. 63/388,356, filed on Jul. 12, 2022, the entire contents of which is incorporated herein by reference.

### FIELD

A system and method for accelerometer-based voice activity detection.

### BACKGROUND

Voice activity detection (VAD) is a method of detecting the voice of a user. Conventional VAD systems/methods use microphones to perform VAD. However, these microphone-based VAD solutions are prone to errors in VAD due to ambient noise (e.g., noise other than the user's voice) which may environmental noises such as wind, voices of other speakers, and the like.

### SUMMARY

An example embodiment includes a head worn electronic device comprising a transceiver for communicating with a host device, an accelerometer having a plurality of axes for detecting three-dimensional forces applied to the head worn electronic device, and a processor. The processor is configured to receive a three-dimensional vibration vector from the accelerometer caused by a voice of a user while the head worn electronic device is positioned in a user's ear, process the three-dimensional vibration vector to determine a voice activity detection axis that correlates with vibrations caused by the voice of the user, perform processing of data from the voice activity detection axis to detect voice activity of the user, and send an instruction to the host device via the transceiver to control the host device based on the voice activity detection.

An example embodiment includes a head worn electronic device comprising a transceiver for communicating with a host device, an accelerometer with a plurality of axes for detecting three-dimensional forces applied to the head worn electronic device, and a processor. The processor is configured to receive a three-dimensional vibration vector from the accelerometer caused by a voice of a user while the head worn electronic device is positioned in a user's ear, transmit, via the transceiver, the three-dimensional vibration vector to the host device, receive, via the transceiver, voice activity detection axis coefficients from the host device, compute a voice activity detection axis based on the voice activity detection axis coefficients, the voice activity detection axis correlates with vibrations caused by the voice of the user, perform processing of data from the voice activity detection axis to detect voice activity of the user, and send an instruction to the host device via the transceiver to control the host device based on the voice activity detection.

An example embodiment includes a head worn electronic device host device comprising a transceiver for communicating with a head worn electronic device, and a processor. The processor is configured to receive, via the transceiver, from the head worn electronic device, a three-dimensional vibration vector detected by an accelerometer of the head worn electronic device, the three-dimensional vibration vector caused by a voice of a user while the head worn electronic device is positioned in a user's ear, process the three-dimensional vibration vector to determine a voice activity detection axis that correlates with vibrations caused by the voice of the user, transmit, via the transceiver, the voice activity detection axis to the head worn electronic device for use in voice activity detection of the user, receive, via the transceiver, from the head worn electronic device, an instruction indicating the voice activity detection of the user, and control the host device based on the instruction.

An example embodiment includes a method of controlling a head worn electronic device. The method comprises detecting, by an accelerometer of the head worn electronic device, a three-dimensional vibration vector caused by a voice of a user while the head worn electronic device is positioned in a user's ear, processing the three-dimensional vibration vector to determine a voice activity detection axis that correlates with vibrations caused by the voice of the user, performing processing of data from the voice activity detection axis to detect voice activity of the user, and controlling a host device based on the voice activity detection.

### BRIEF DESCRIPTION OF THE DRAWINGS

So that the manner in which the above recited features of the present disclosure can be understood in detail, a more particular description of the disclosure, briefly summarized above, may be had by reference to example embodiments, some of which are illustrated in the appended drawings. It is to be noted, however, that the appended drawings illustrate only example embodiments of this disclosure and are therefore not to be considered limiting of its scope, for the disclosure may admit to other equally effective example embodiments.

FIG. 1 shows an illustration of an earbud with accelerometer axes, according to an example embodiment of the present disclosure.

FIG. 2 shows a waveform of voice activity detection, according to an example embodiment of the present disclosure.

FIG. 3 shows a flowchart of voice activity detection, according to an example embodiment of the present disclosure.

FIG. 4 shows a block diagram of the hardware details of the earbud in FIG. 1, according to an example embodiment of the present disclosure.

FIG. 5 shows a block diagram of wireless communication between earbuds and a smartphone, according to an example embodiment of the present disclosure.

FIG. 6A shows an illustration of a first orientation of the earbud relative to the user, according to an example embodiment of the present disclosure.

FIG. 6B shows an illustration of a second orientation of the earbud relative to the user, according to an example embodiment of the present disclosure.

FIG. 7 shows a flowchart of a method of determining orientation of the earbud using projection, according to an example embodiment of the present disclosure.

FIG. 8 shows a flowchart of a method of determining orientation of the earbud using beamforming, according to an example embodiment of the present disclosure.

FIG. 9 shows a flowchart of voice activity detection after determining earbud orientation, according to an example embodiment of the present disclosure.

### DETAILED DESCRIPTION

Various example embodiments of the present disclosure will now be described in detail with reference to the drawings. It should be noted that the relative arrangement of the components and steps, the numerical expressions, and the numerical values set forth in these example embodiments do not limit the scope of the present disclosure unless it is specifically stated otherwise. The following description of at least one example embodiment is merely illustrative in nature and is in no way intended to limit the disclosure, its application, or its uses. Techniques, methods and apparatus as known by one of ordinary skill in the relevant art may not be discussed in detail but are intended to be part of the specification where appropriate. In all the examples illustrated and discussed herein, any specific values should be interpreted to be illustrative and non-limiting. Thus, other example embodiments could have different values. Notice that similar reference numerals and letters refer to similar items in the following figures, and thus once an item is defined in one figure, it is possible that it need not be further discussed for the following figures. Below, the example embodiments will be described with reference to the accompanying figures.

In today's connected environment, more users are using head worn electronic devices such as wireless earbuds, headphones and other devices to interact with and control their host devices including smart devices (e.g., smartphones). For example, a user may use a head worn electronic device to listen to music and make phone calls. In order to provide a hands-off experience, the smart device may provide voice activity detection (VAD) capabilities where the head worn electronic device and smart device work together to detect user speech, understand spoken commands and control the smart device and/or head worn electronic device accordingly. For example, if the user is listening to a music on a smart phone and wants to make a phone call, the user can speak commands such as “Make a Phone Call”, or “Call John Smith”, etc. The VAD may detect that the user is speaking, interpret the speech to identify a spoken command, and control the smart phone to interrupt the music and place the desired call. Of course, many other examples of VAD and smart device control are possible (e.g., commands to skip songs, control volume, send text messages, etc.).

Examples of accelerometer-based VAD systems/methods are described herein. The examples shown in the figures and described herein are directed to wireless earbuds for ease of description. However, it should be noted that the accelerometer-based VAD systems/methods described herein are not limited to wireless earbuds and can be implemented in any type of head worn electronic device (e.g., headphones, virtual reality goggles, etc.).

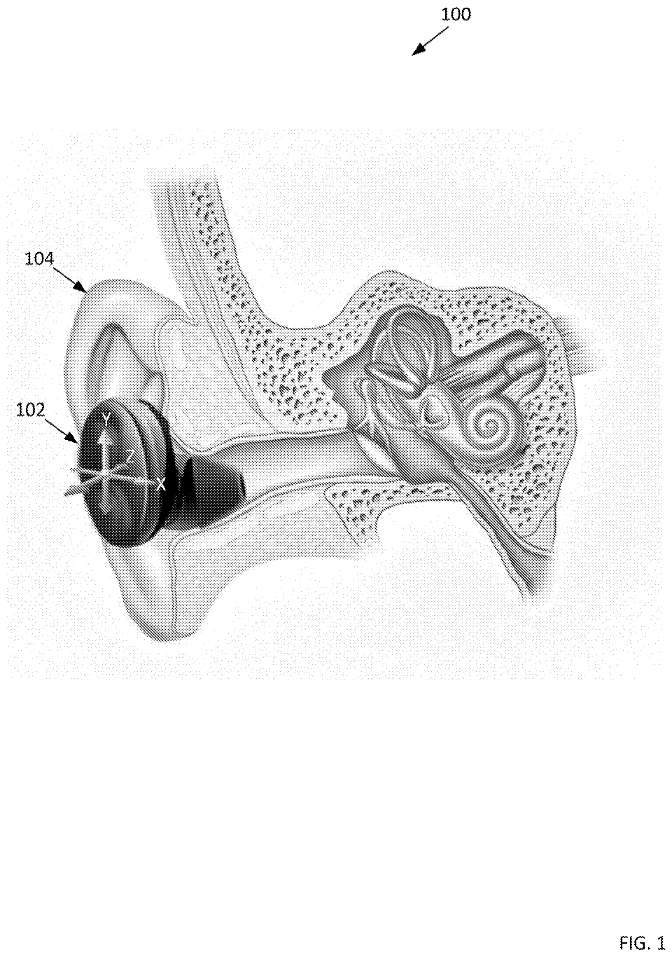

FIG. 1 shows an illustration 100 of an earbud, according to an example embodiment of the present disclosure. Head worn electronic devices such as the wireless earbud 102 shown in FIG. 1 may include an integrated accelerometer (not shown) having a plurality of detection axes (e.g., X, Y and Z axis) for detecting vibrational forces (e.g., a three-dimensional vibration vector) and orientation of wireless earbud 102 in three-dimensional space. As will be described in more detail below, VAD is performed by detecting vibrations caused by the user's anatomy during speech, and orientation of wireless earbud 102 relative to the user's ear 104 or other user anatomical features (e.g., user's head, user's jaw, etc.) is determined with a goal of improving VAD performance (e.g., decrease false positives/negatives).

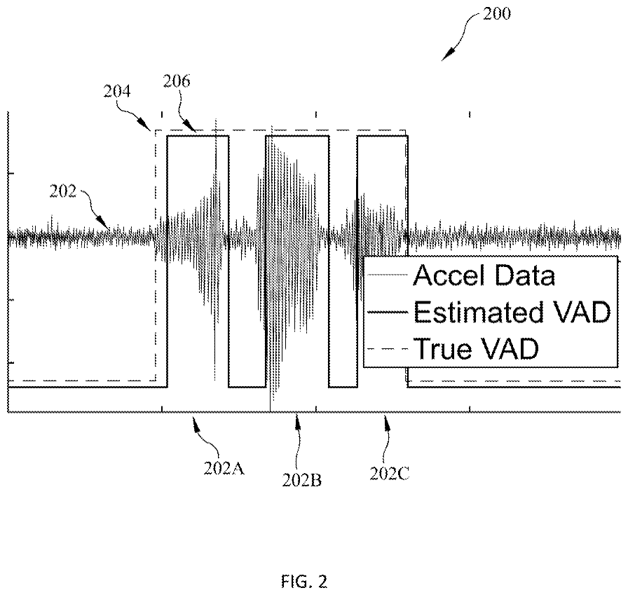

FIG. 2 shows waveforms 200 of voice activity detection, according to an example embodiment of the present disclosure. Waveform 202 is the amplitude of the accelerometer data detected over a time period by the accelerometer integrated into wireless earbud 102. A shown, waveform 202 is initially relatively flat (e.g., little vibration is detected) until time windows 202A, 202B and 202C where the amplitude peaks due to increased vibration detection. This vibration may be caused, for example, by vibration in the user's anatomy (e.g., vocal cord vibration that propagates to the user's jaw) due to the user's voice commands. Therefore, the true VAD occurs in a time window indicated by waveform 204, while the estimated VAD is shown by waveform 206. In other words, when the vibrations exceed a threshold, the VAD system/method determines that the user is speaking. When the VAD determines that the user is speaking, the VAD algorithm controls the smart device and/or wireless earbud 102 to detect the speech (e.g., commands) being spoken by the user. This may include the smart device interrupting the current smart device activity (e.g., music), turning on the microphone integrated in wireless earbud 102 and initiating keyword spotting (KWS). The KWS may include processing the user's speech to identify spoken commands (e.g., “make phone call”, “send text message”, etc.) that can be used for control purposes. Once the smart device identifies spoken commands, the smart device controls software applications according to these commands. For example, if the spoken command identified during KWS is “Call Tom Smith”, then the smart device may open the telephone application and place a call to Tom Smith, at which point the user may converse with Tom Smith via the microphone and speakers in wireless earbud 102. Once the phone call is complete, the user can command the smart device to “hang up”, at which point the smart device may resume playing music for the user's enjoyment.

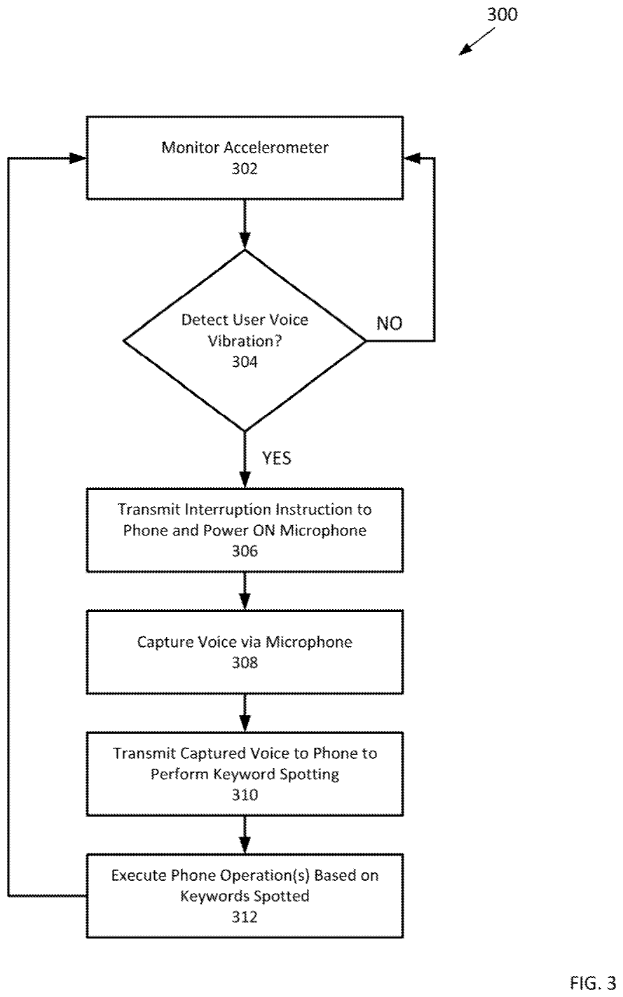

FIG. 3 shows a flowchart 300 of voice activity detection, according to an example embodiment of the present disclosure. In step 302, the accelerometer data (e.g., vibration data) is monitored by the wireless earbud. In step 304, a determination is made whether the vibration indicates a user's voice detection or not. This determination can be made by the wireless earbud comparing the detected vibration to one or more predetermined vibration thresholds which may include thresholds in one or more of vibration amplitude, vibration frequency or vibration duration. If user voice vibration is not detected, the vibration monitoring continues. If, however, voice vibration is detected, the wireless earbud transmits an interruption instruction to the smart device in step 306. This interruption instruction may instruct the smart device to stop (i.e. temporarily suspend) the current software application and power ON the microphone in the wireless earbud in step 308 to initiate KWS. In step 310, the wireless earbud transmits the captured voice to the smart device for KWS processing which may include identifying specific voice commands. In step 312, the results of KWS are used to execute operations (e.g., control software applications, etc.) accordingly. After the actions are performed based on the user's commands, the smart device and the wireless earbud may resume normal operations and continue to monitor the accelerometer for additional vibrations. It is noted that after the KWS captures the user's voice, the wireless earbud may power OFF the microphone to conserve earbud battery life.

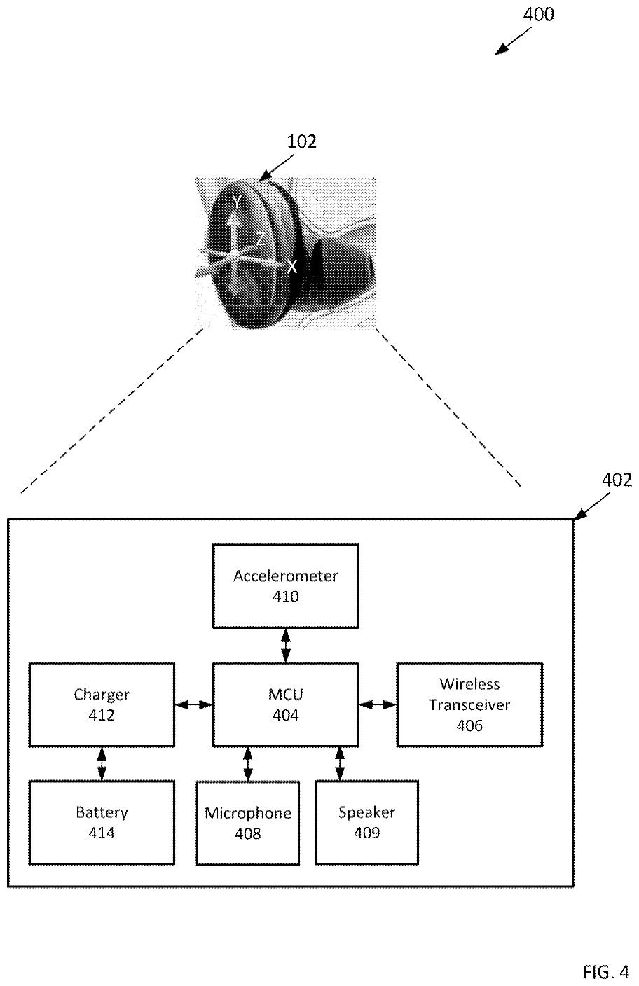

FIG. 4 shows a block diagram 400 of hardware details of the earbud in FIG. 1, according to an example embodiment of the present disclosure. As shown, wireless earbud 102 includes hardware components 402. These hardware components may include but are not limited to micro-controller unit (MCU) 404 which may include a processor or application specific integrated circuit (ASIC) and associated memory devices that control the overall operation of wireless earbud 102. Also included in the hardware configuration may be wireless transceiver 406 (e.g., Bluetooth transceiver, etc.) for facilitating wireless communications between wireless earbud 102 and the smart device (not shown), microphone 408 for detecting the user's voice and speaker 409 for outputting sound to the user, and accelerometer 410 for detecting vibrations due to the user's voice. Wireless earbud 102 may also include battery 414 for powering the hardware and charger 412 (e.g., wireless charger) for charging the battery. Although not shown, it is noted that another wireless earbud may be paired with wireless earbud 102. This other wireless earbud may include similar hardware components with the possible exception redundant hardware that may be excluded to reduce costs, complexity, and power consumption (e.g., redundant accelerometer 410 and microphone 408 may be excluded in the other earbud). It is also noted that while these hardware details are described with respect to wireless earbud 102, these hardware details would be similar in other wireless head worn devices not shown.

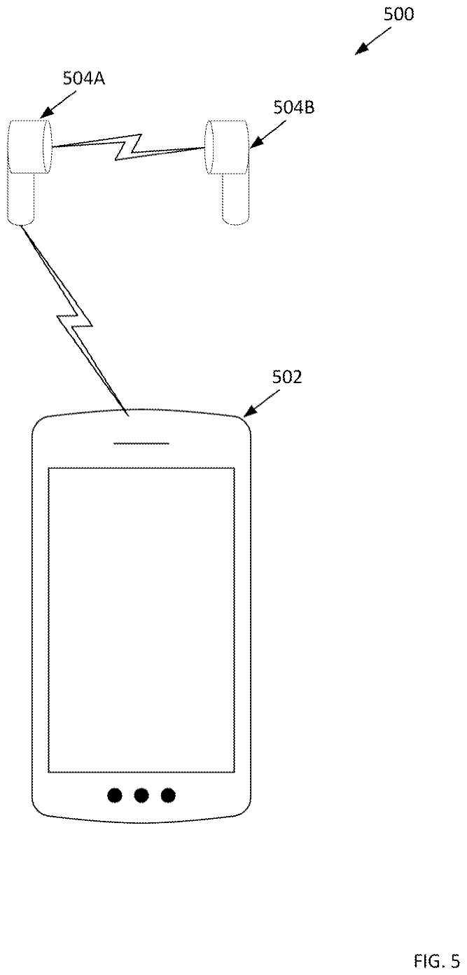

FIG. 5 shows a block diagram 500 of wireless communication between earbuds and a smartphone, according to an example embodiment of the present disclosure. In this example, the smart device is illustrated as smartphone 502 which wirelessly communicates with wireless earbuds 504A/504B in a piconet. For example, the user may control smartphone 502 to pair with wireless earbuds 504A/504B via Bluetooth or any other wireless protocol. This communication may be accomplished by one of the wireless earbuds (e.g., earbud 504A) acting as the primary earbud and the other wireless earbud (e.g., earbud 504B) acting the secondary earbud. During operation, wireless signals are transmitted to/from smartphone 502 and primary earbud 504A. The wireless signals are then relayed from primary earbud 504A to secondary earbud 504B. Of course, there could be configurations where both wireless earbuds 504A/504B communicate directly with smartphone 502.

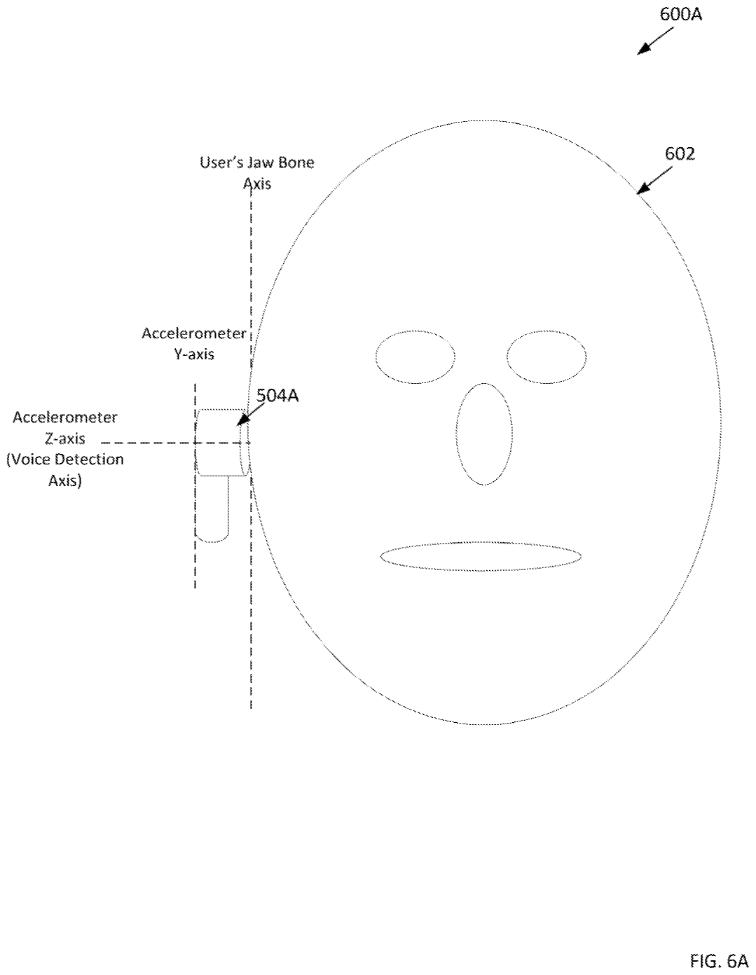

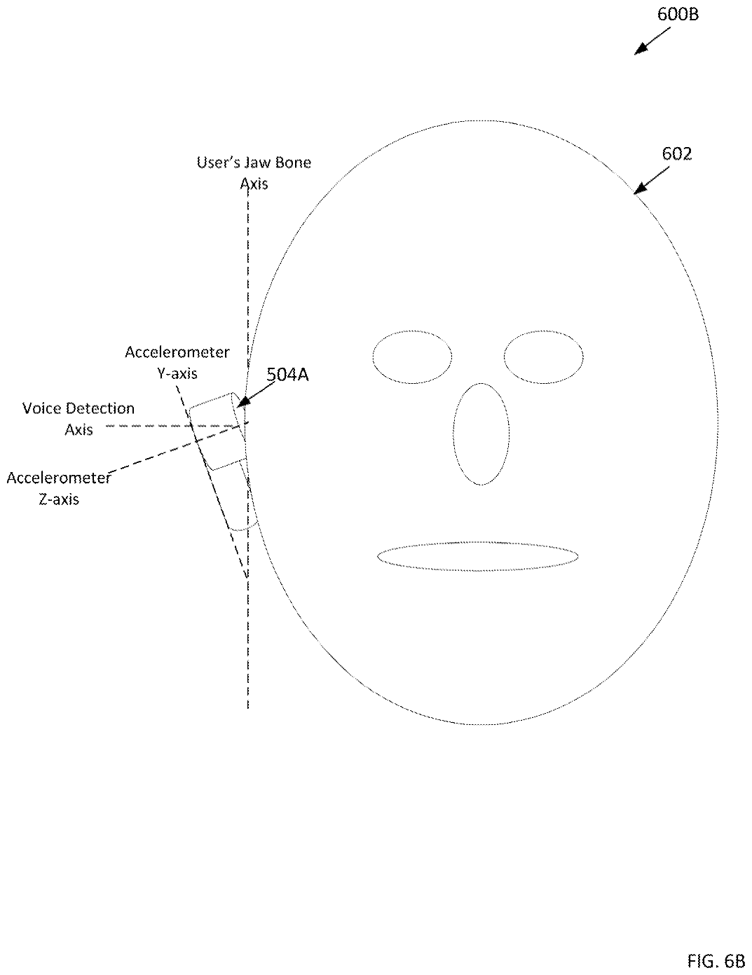

FIG. 6A shows an illustration 600A of a first orientation of the earbud relative to the user, according to an example embodiment of the present disclosure. As shown in FIG. 6A, user 602 has inserted wireless earbud 504A into their ear in a first orientation. In this first orientation, an axis (e.g., Y-axis) of the accelerometer in wireless earbud 504A is parallel with an axis related to a certain anatomical feature (e.g., jawbone axis) of user 602. It is noted that this orientation is beneficial because vibrations are strongest on an axis (e.g., Z-axis) that is perpendicular to the axis (e.g., jawbone axis) related to the anatomical feature of user 602 (e.g., the detected three-dimensional vibration vector directly aligns with the Z-axis). Therefore, vibration detection is best performed on a voice activity detection axis (e.g., Z-axis in this case) that is perpendicular to the axis related the anatomical feature of user 602. In FIG. 6A, the vibration detection axis directly coincides with an axis (e.g., Z-axis) of the accelerometer. Therefore, in this orientation, voice detection can be performed based on the vibration signal corresponding directly to the Z-axis (e.g., optimal signal to noise ratio (SNR) for VAD is achieved directly on the Z-axis). It should be noted that in order for the vibration detection axis to directly coincide with the Z-axis, the X-axis (not shown for ease of description) may also be in parallel to another designated anatomy axis (e.g., another anatomical axis that is perpendicular to the user's jawbone axis shown in FIG. 6A).

In practice, the first orientation in FIG. 6A is unlikely to be achieved due to incorrect positioning of the earbud within the ear of user 602, differing anatomy between users, and manufacturing alignment anomalies of the accelerometer within the earbud. In other words, the vibration detection axis may be skewed in the Y-axis and/or the X-axis directions and therefore may not directly coincide with the Z-axis. Therefore, the Z-axis may not be the optimal axis for performing voice detection. Performing VAD on the Z-axis in such a configuration may lead to incorrect VAD (e.g., false positives and false negatives).

FIG. 6B shows an illustration 600B of a second orientation of the earbud relative to the user, according to an example embodiment of the present disclosure. As shown in FIG. 6B, user 602 has inserted wireless earbud 504A into their ear in a second orientation. In this second orientation, an axis (e.g., Y-axis) of the accelerometer in wireless earbud 504A is no longer parallel with an axis related to a certain anatomical feature (e.g., jawbone axis) of user 602. It noted the X-axis (not shown for ease of description) may also not be in parallel to the other designated anatomy axis (not shown for ease of description).

The orientation shown in FIG. 6B may be problematic, because as described above, voice caused vibrations (e.g., the three-dimensional vibration vector) is strongest on an axis that is perpendicular to the axis (e.g., jawbone axis) related to the anatomical feature of user 602. Therefore, in this configuration, vibration detection would be more accurately performed on a voice activity detection axis that does not directly coincide with an axis (e.g., Z-axis) of the accelerometer. For example, the voice activity detection axis (optimal detection axis) may be skewed from the Z-axis along one or more of the X-axis and Y-axis. In other words, the voice vibration is a three-dimensional vibration vector that has X, Y and Z components that should be captured/combined in an intelligent manner to optimize SNR for performing VAD operations (e.g., the three-dimensional vibration vector is skewed from the Z-axis). The disclosure herein describes methods for determining the voice activity detection axis in such a situation in order to attain optimal SNR when performing VAD operations.

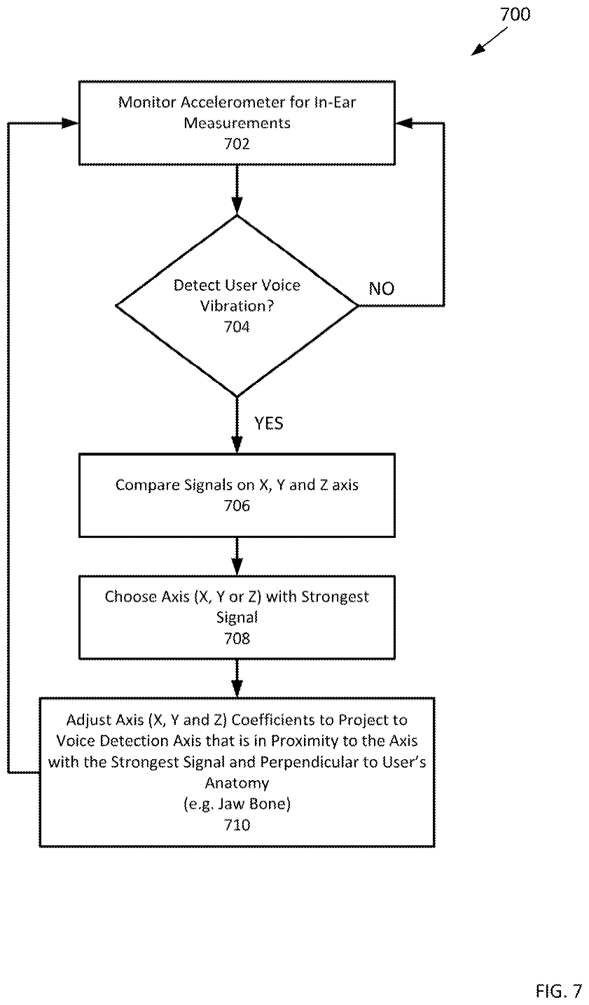

Once such method for determining the voice activity detection axis is described in the flowchart 700 of FIG. 7 which describes a method of determining orientation of the accelerometer using projection, according to an example embodiment of the present disclosure. In step 702, the accelerometer 410 is monitored by MCU 404 for vibrations. This initial monitoring may be performed by monitoring the vibration values on the X, Y and Z axes. In step 704, if user voice vibrations are not detected, the monitoring continues in step 702. However, if user voice vibrations are detected (e.g., vibrations are greater than a threshold), then the method proceeds in step 706 to analyze the vibration signals detected on the X, Y and Z axes. The analysis may include determination of amplitude, frequency and/or duration of the vibrations on each of the three axes over a period of time. In step 708, for example, the axis (e.g., X, Y or Z axis) having the strongest signal may be chosen as a starting point. This axis is likely to be the Z-axis given that the Z-axis is closest to perpendicular to the user's anatomy. In step 710, the method adjusts the axis coefficients to project the initial axis onto a voice activity detection axis that is in proximity to the axis with the strongest signal. For example, the method may use the amplitude of the vibrations on the X-axis and Y-axis to project the initial Z-axis in the X and Y directions by an amount corresponding to their respective amplitudes. Projection may be performed based on Equation (1) below:

y=R₁₁Accₓ+R₁₂Acc_{y}+R₁₃Acc_{z} Equation (1)
where Accₓ, Accₓ, and Accₓ are the accelerometer values on the respective axes, and
where R₁₁, R₁₂ and R₁₃ are the axis projection coefficients that act as weights for the projection

This projection coefficients (i.e., weights) are then used by MCU 404 to compute the voice activity detection axis for the next cycle through the VAD operations. Computation of the projection coefficients and voice activity detection axis may be performed once per user fit (i.e., once each time the user places the earbud in their ear for a session). Alternatively, adjustments of the projection coefficients and voice activity detection axis may be performed periodically or event driven after the initial user fit. For example, each time the user speaks a command, the projection coefficients and voice activity detection axis may be adjusted in order to fine tune the voice activity detection axis and adapt to any changes in orientation that may occur while the user is wearing the earbud.

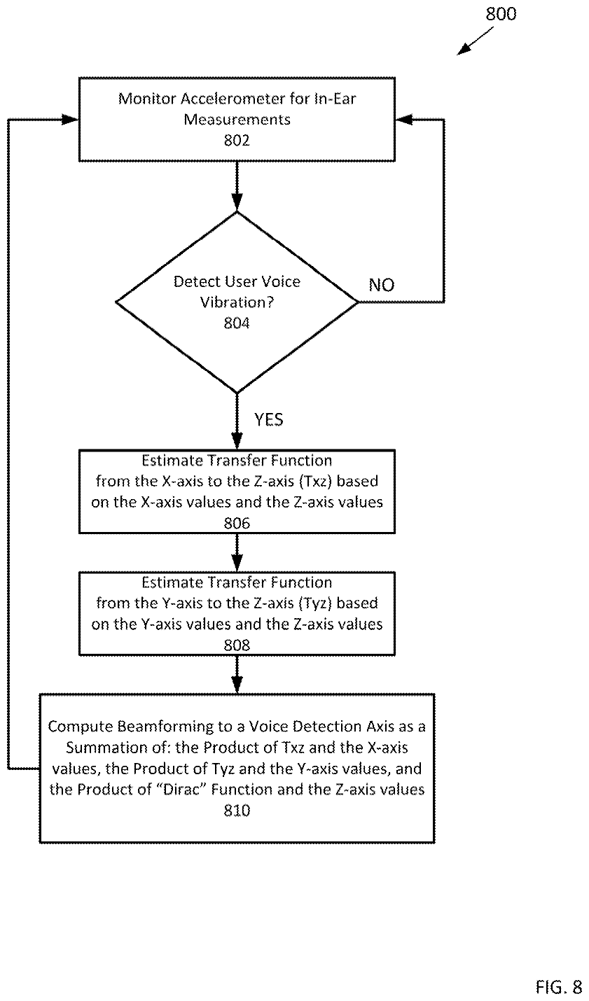

Another such method for determining the voice activity detection axis is described in the flowchart 800 of FIG. 8 which describes a method of determining orientation using beamforming, according to an example embodiment of the present disclosure. In step 802, the accelerometer 410 is monitored by MCU 404 for vibrations. In step 804, if user voice vibrations are not detected, the monitoring continues in step 802. However, if user voice vibrations are detected (e.g., vibrations on one or more of the axes are greater than a threshold), then the method proceeds to analyze the vibration signals detected on the X, Y and Z axes and estimate transfer functions of the axes. The analysis may include determination of amplitude, frequency and/or duration of the vibrations on each of the three axes over a period of time. For example, in step 806, then method estimates the transfer function from the X-axis to the Z-axis (Txz) based on the X-axis values and the Z-axis values. Likewise, in step 808, the method estimates the transfer function from the Y-axis to the Z-axis (Tyz) based on the Y-axis values and the Z-axis values. The estimations of transfer functions may be performed based on Equation (2) below:

Estimate Txz=FFT(Acc_{z})·/FFT(Acc_{y})

Estimate Tyz=FFT(Acc_{z})·/FFT(Accₓ) Equation (2)
where FFT is the Fast Fourier Transform, and
where Accₓ, Accₓ, and Accₓ are the accelerometer values on the respective axes

Once the transfer functions are computed, in step 810 the method performs beamforming of axis values using beamforming coefficients (i.e., weights) based on the transfer functions to determine the voice activity detection axis. For example, the vibration values detected on the X and Y axes can be multiplied by the transfer function to transform the X and Y axis values to the Z axis, and the Z-axis vibration values can be multiplied by an impulse function. Beamforming may be performed based on Equation (3) below:

Beamforming Output=IFFT(Txz)*Accₓ+IFFT(Tyz)*Acc_{y}+DIRAC*Acc_{z} Equation (3)
where IFFT is the Inverse Fast Fourier Transform,
where Accₓ, Accₓ, and Accₓ are the accelerometer values on the respective axes,
where DIRAC is an impulse function,
where IFFT(Txz), IFFT(Tyz), and DIRAC are the beamforming coefficients

This beamformed output is then used as the voice activity detection axis for the next cycle through the VAD operations. Computation of the beamforming coefficients and voice activity detection axis may be performed once per user fit (i.e., once each time the user places the earbud in their ear for a session). Alternatively, adjustments of beamforming coefficients and the voice activity detection axis may be performed periodically or event driven after the initial user fit. For example, each time the user speaks a command, the beamforming coefficients and voice activity detection axis may be adjusted to fine tune the voice activity detection axis and adapt to any changes in orientation that may occur while the user is wearing the earbud.

It is noted that the method steps in FIG. 7 and FIG. 8 can be performed by MCU 404, the processor (not shown) of smartphone 502 or a combination of the two. For example, MCU 404 can monitor the accelerometer and determine the voice detection axis using the methods described above. In another example, MCU 404 can monitor the accelerometer and use wireless transceiver 406 to transmit vibration data to the host device (e.g., smartphone 502) which then determines the voice detection axes using the methods described above and transmits the voice activity detection axis coefficients (e.g., projection coefficients or beamforming coefficients) back to MCU 404 to compute the voice activity detection axis. In either case, MCU 404 utilizes the voice activity detection axis to perform VAD.

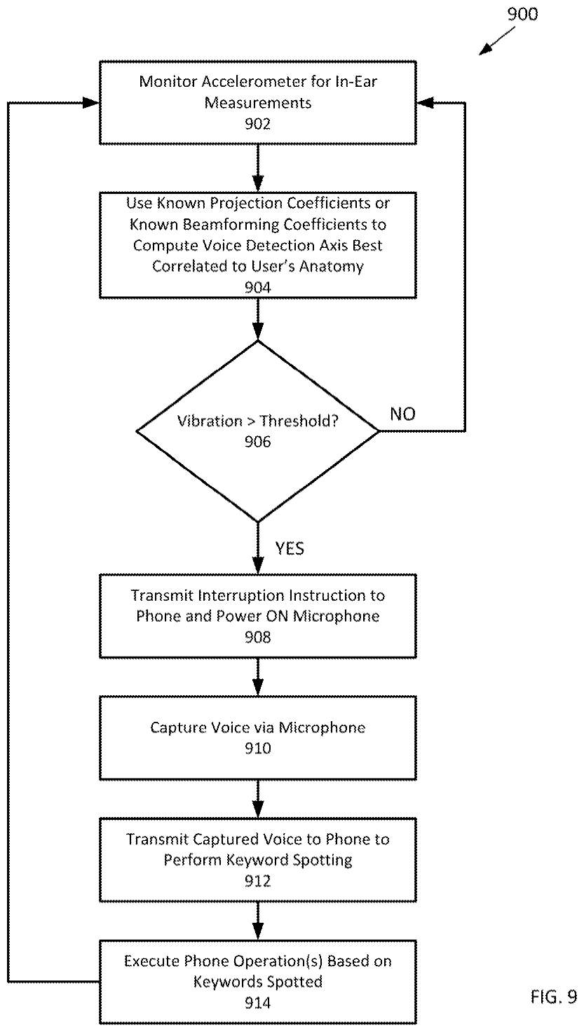

Regardless of the method utilized above, once the voice activity detection axis is determined, flowchart 900 of FIG. 9 describes operations of performing voice activity detection, according to an example embodiment of the present disclosure. In step 902, MCU 404 monitors the accelerometer for vibrations. This monitoring may be performed on the previously determined voice activity detection axis. Specifically, in step 904, MCU 404 uses known voice activity detection axis coefficients (e.g., known projection coefficients or known beamforming coefficients) to compute voice activity detection axis best correlated to an axis perpendicular to the user's anatomy. If in step 906, the user voice vibrations are detected (e.g., vibrations are greater than a threshold), then the method proceeds to step 908 where MCU 404 controls transceiver 406 to transmit an interruption instruction to the smart device 502. MCU 404 also powers ON the microphone 408 to capture the user's voice in step 910. The captured user's voice is then transmitted in step 912 via transceiver 406 to the smart device for analysis such as KWS. The smart device, for example, may perform KWS on the captured voice to spot keywords which are then used to execute operations in step 914. Once the operations are complete, MCU 404 may proceed to monitor the accelerometer again in step 902 and the process is repeated.

As mentioned above, MCU 404 monitors accelerometer 410 and controls the operation of microphone 408 to capture the user's speech. MCU 404 may also perform the other analysis steps (e.g., projection, beamforming, KWS, etc.) described in FIGS. 7-9. However, due to computational/power limitations, it is beneficial to limit the processing performed directly by MCU 404. Thus, more computationally intensive steps (e.g., projection, beamforming, KWS, etc.) are generally delegated to smartphone 502 to extend the battery life of the earbuds, while the results of these computations (e.g., the computed voice activity detection axis) may be used by MCU 404 to perform VAD.

In addition to the automated determination of the voice activity detection axis by the methods described above, it is also noted that the voice activity detection axis may be manually fine-tuned by the user. For example, the host device (e.g., smartphone) may display controls (e.g., virtual slider button or the like) via a software application that allow the user to adjust the voice activity detection axis coefficients (e.g., projection coeffects or beamforming coefficients) which result in an adjustment of the voice activity detection axis computed by MCU 404. This adjustment may be performed by the user speaking test commands, the application presenting VAD results to the user, the user evaluating the VAD results and manually adjusting (e.g., via the virtual slider button or the like) the voice activity detection axis to increase accuracy of VAD operations.

The disclosure herein provides various benefits including but not limited to increased accuracy of VAD at low cost and low power consumption. For example, by using an accelerometer rather than a microphone, VAD can be improved by avoiding false detections due to environmental noise (e.g., wind noise, other speakers in proximity to the user, etc.) which have little to no effect on the accelerometer output (i.e., any vibrations due to wind, sound from other speakers voices, etc. detected by the accelerometer are too small to trigger VAD). In addition, by determining and utilizing an optimal voice activity detection axis that deviates from the axes of the accelerometer, the SNR can further be optimized. In general, increased accuracy of VAD results in less false positives (i.e. wrongly detecting voice activity) and false negatives (i.e. missing voice activity) which leads to a better user experience and longer battery life of the earbuds. It is noted that although a three-dimensional accelerometer was described herein, the methods can be extended to work with an accelerometer with more than three axes (e.g., 6-axis accelerometer) to achieve a more accurate determination of the voice activity detection axis.

While the foregoing is directed to example embodiments described herein, other and further example embodiments may be devised without departing from the basic scope thereof. For example, aspects of the present disclosure may be implemented in hardware or software or a combination of hardware and software. One example embodiment described herein may be implemented as a program product for use with a computer system. The program(s) of the program product define functions of the example embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed example embodiments, are example embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

What is claimed is:

1. A head worn electronic device comprising:
a transceiver for communicating with a host device;
an accelerometer having a plurality of axes for detecting three-dimensional forces applied to the head worn electronic device; and
a processor configured to:
receive a three-dimensional vibration vector from the accelerometer caused by a voice of a user while the head worn electronic device is positioned in a user's ear;
process the three-dimensional vibration vector to determine a voice activity detection axis that correlates with vibrations caused by the voice of the user;
perform processing of data from the voice activity detection axis to detect voice activity of the user; and
send an instruction to the host device via the transceiver to control the host device based on the voice activity detection.

2. The head worn electronic device of claim 1, wherein the voice activity detection axis is perpendicular to an anatomical feature of the user.

3. The head worn electronic device of claim 1, wherein the voice activity detection axis is remote from the plurality of axes of the accelerometer.

4. The head worn electronic device of claim 1, further comprising:
a microphone,
wherein the processor is further configured to:
send the instruction to suspend operation of the host device,
activate the microphone to capture voice of the user,
perform keyword spotting of the captured voice, and
control the host device based on the keyword spotting.

5. The head worn electronic device of claim 1, wherein the processor is further configured to determine the voice activity detection axis that correlates with vibrations caused by the voice of the user by applying axes coefficients to force values detected on the plurality of axes to project the three-dimensional vibration vector onto the voice activity detection axis.

6. The head worn electronic device of claim 1, wherein the processor is further configured to determine the voice activity detection axis that correlates with vibrations caused by the voice of the user by applying transfer functions of the plurality of axes to force values detected on the plurality of axes to beamform the three-dimensional vibration vector onto the voice activity detection axis.

7. A head worn electronic device comprising:
a transceiver for communicating with a host device;
an accelerometer with a plurality of axes for detecting three-dimensional forces applied to the head worn electronic device; and
a processor configured to:
receive a three-dimensional vibration vector from the accelerometer caused by a voice of a user while the head worn electronic device is positioned in a user's ear;
transmit, via the transceiver, the three-dimensional vibration vector to the host device;
receive, via the transceiver, voice activity detection axis coefficients from the host device,
compute a voice activity detection axis based on the voice activity detection axis coefficients, the voice activity detection axis correlates with vibrations caused by the voice of the user;
perform processing of data from the voice activity detection axis to detect voice activity of the user; and
send an instruction to the host device via the transceiver to control the host device based on the voice activity detection.

8. The head worn electronic device of claim 7, wherein the voice activity detection axis is perpendicular to an anatomical feature of the user.

9. The head worn electronic device of claim 7, wherein the voice activity detection axis is remote from a plurality of axes of the accelerometer.

10. The head worn electronic device of claim 7, further comprising:
a microphone,
wherein the processor is further configured to:
send the instruction to suspend operation of the host device,
activate the microphone to capture voice of the user, and
transmit the captured voice to the host device for use in keyword spotting of the captured voice and control of the host device based on the keyword spotting.

11. The head worn electronic device of claim 7, wherein the computed voice activity detection axis correlates with vibrations caused by the voice of the user due to applying axes coefficients to force values detected on the plurality of axes to project the three-dimensional vibration vector onto the voice activity detection axis.

12. The head worn electronic device of claim 7, wherein the computed voice activity detection axis that correlates with vibrations caused by the voice of the user due to applying transfer functions of the plurality of axes to force values detected on the plurality of axes to beamform the three-dimensional vibration vector onto the voice activity detection axis.

13. A head worn electronic device host device comprising:
a transceiver for communicating with a head worn electronic device; and
a processor configured to:
receive, via the transceiver, from the head worn electronic device, a three-dimensional vibration vector detected by an accelerometer of the head worn electronic device, the three-dimensional vibration vector caused by a voice of a user while the head worn electronic device is positioned in a user's ear,
process the three-dimensional vibration vector to determine a voice activity detection axis that correlates with vibrations caused by the voice of the user,
transmit, via the transceiver, the voice activity detection axis to the head worn electronic device for use in voice activity detection of the user,
receive, via the transceiver, from the head worn electronic device, an instruction indicating the voice activity detection of the user, and
control the host device based on the instruction.

14. The head worn electronic device host device of claim 13, wherein the host device is further configured to:
receive captured voice from the head worn electronic device,
perform keyword spotting of the captured voice, and
control host device applications based on the keyword spotting.

15. The head worn electronic device host device of claim 13, wherein the host device is further configured to determine the voice activity detection axis that correlates with vibrations caused by the voice of the user by applying axes coefficients to force values detected by the accelerometer to project the three-dimensional vibration vector onto the voice activity detection axis.

16. The head worn electronic device host device of claim 13, wherein the host device is further configured to determine the voice activity detection axis that correlates with vibrations caused by the voice of the user by applying transfer functions of axes of the accelerometer to force values detected by the accelerometer to beamform the three-dimensional vibration vector onto the voice activity detection axis.

17. A method of controlling a head worn electronic device, the method comprising:
detecting, by an accelerometer of the head worn electronic device, a three-dimensional vibration vector caused by a voice of a user while the head worn electronic device is positioned in a user's ear;
processing the three-dimensional vibration vector to determine a voice activity detection axis that correlates with vibrations caused by the voice of the user;
performing processing of data from the voice activity detection axis to detect voice activity of the user; and
controlling a host device based on the voice activity detection.

18. The method of claim 17, further comprising:
suspending operation of the host device in response to the voice activity detection;
activating a microphone of the head worn electronic device to capture voice of the user;
performing keyword spotting of the captured voice; and
controlling the host device based on the keyword spotting.

19. The method of claim 17, further comprising:
determining the voice activity detection axis that correlates with vibrations caused by the voice of the user by applying axes coefficients to force values detected by the accelerometer to project the three-dimensional vibration vector onto the voice activity detection axis.

20. The method of claim 17, further comprising:
determining, the voice activity detection axis that correlates with vibrations caused by the voice of the user by applying transfer functions of axes of the accelerometer to force values detected by the accelerometer to beamform the three-dimensional vibration vector onto the voice activity detection axis.
